(19) United States
(12) Patent Application Publication
(10) Pub. No.: US 2024/0427746 A1
(43) Pub. Date: Dec. 26, 2024

(54) TESTING SYSTEM AND TESTING METHOD FOR SENSOR DATA OF MONITORING SYSTEM

(71) Applicant: CHICONY POWER TECHNOLOGY CO., LTD., NEW TAIPEI CITY (TW)

(72) Inventors: Tse-Wen CHANG, NEW TAIPEI CITY (TW); Jewel TSAI, NEW TAIPEI CITY (TW); Te-Mei TU, NEW TAIPEI CITY (TW); Wen-Yen CHENG, NEW TAIPEI CITY (TW)

(21) Appl. No.: 18/386,578

(22) Filed: Nov. 2, 2023

(30) Foreign Application Priority Data
Jun. 21, 2023 (TW) 112123457

(51) Int. Cl. G06F 16/215; G01M 99/00

(52) U.S. Cl. CPC G06F 16/215; G01M 99/00

(57) ABSTRACT

A testing system for sensor data of a monitoring system including a server and multiple sensors is disclosed. The server includes a data pre-process module, a value classifying-computing module, and a value comparing module. The data pre-process module performs a data cleaning procedure to sensor data of the multiple sensors to generate multiple cleaned data. The value classifying-computing module computes a difference-value combination of multiple cleaned data of every two sensors in a designated order-direction. The value comparing module subtracts a measuring-accuracy value from every difference-value of each difference-value combination to obtain multiple second difference-value combinations, computes a first feature value of each second difference-value combination, and records a label to two sensors corresponding to one of the second difference-value combinations when a p-value corresponding to the first feature value of the second difference-value combination is determined to be less than a threshold.

### BACKGROUND OF THE INVENTION

### 1. Technical Field

The present disclosure relates to a testing system and a testing method, and specifically to a testing system and a testing method for sensor data.

### 2. Description of Related Art

Recently, in order to achieve the purpose of zero emissions, many areas have been conducting carbon-emission analysis and carbon-reduction strategy planning. For effective analysis and planning, it is necessary to collect data over a period of time through multiple sensors arranged in the areas or the buildings. In other words, the correctness of sensor data is importance for the long-term purpose of zero emissions.

In order to achieve the purpose of centralized control and management of electromechanical system, traditional buildings are usually arranged with a central monitoring system. Under the central monitoring system, the buildings also arrange multiple sensors for the central monitoring system to implement precise control. To ensure the accuracy of the sensor data, the traditional central monitoring system can only define simple upper and lower limit of the sensors to reasonable values or perform regular sensor calibration. However, the above approach cannot avoid the risk of inaccurate system control due to the deviation of some certain sensor data during daily operation.

Therefore, how to detect an abnormal sensor based on analyzing and comparing the sensor data and then remind the user to maintain the sensor, is a critical topic for people in this technical field.

### SUMMARY OF THE INVENTION

The present disclosure is directed to a testing system and a testing method for sensor data of a monitoring system, which may record a label for at least two sensors when a significant difference of the sensing data of the at least two sensors is found, so as to find the abnormal sensor(s) in real-time.

In one of the exemplary embodiments, the testing system including:
multiple sensors corresponding to same certain category, wherein each of the multiple sensors respectively generates multiple sensing data;
multiple I/O modules each respectively connected with one of the multiple sensors to continuously collect the multiple sensing data of each of the multiple sensors;
a server, connected with the multiple I/O modules through a network communication apparatus to receive the multiple sensing data of the multiple sensors, and including:
a data pre-process module, configured to perform a data cleaning procedure to the multiple sensing data of the multiple sensors to respectively generate multiple cleaned data for each of the multiple sensors;
a value classifying-computing module, configured to compute multiple difference values of the multiple cleaned data of any two of the multiple sensors in accordance with a designated order-direction to generate multiple difference-value combinations; and
a value comparing module, configured to obtain a measuring-accuracy value of the certain category, respectively subtract the measuring-accuracy value from the multiple difference values of each of the multiple difference-value combinations to obtain multiple second difference-value combinations, perform a normalizing process to each of the multiple second difference-value combinations, respectively calculate a first feature value of each of the second difference-value combinations, respectively obtain a p-value corresponding to each of the second difference-value combinations based on each of the second difference-value combinations and its first feature value, and record a label for two of the sensors associated with one of the second difference-value combinations when the p-value corresponding to the first feature value of the second difference-value combination is determined to be less than a first default value.

In one of the exemplary embodiments, the testing method of the present disclosure is incorporated with the above testing system and includes following steps:
a) collecting multiple sensing data of the multiple sensors by the server;
b) classifying, by the server, the multiple sensing data to gather the multiple sensing data of the multiple sensors of a certain category;
c) performing, by the server, a data cleaning procedure to the multiple sensing data of the multiple sensors to respectively generate multiple cleaned data of each of the sensors;
d) calculating, by the server, multiple difference values of the multiple cleaned data of any two of the multiple sensors based on a designated order-direction to generate multiple difference-value combination;
e) obtaining, by the server, a measuring-accuracy value of the certain category;
f) respectively subtracting the measuring-accuracy value from the multiple difference values of each of the difference-value combinations to obtain multiple second difference-value combinations by the server; and
g) performing a normalizing process to each of the second difference-value combinations, respectively calculating a first feature value of each of the second difference-value combinations, respectively obtaining a p-value corresponding to each of the second difference-value combinations based on each of the second difference-value combinations and its first feature value, and recording a label for two of the multiple sensors associated with one of the multiple second difference-value combinations when the p-value corresponding to the first feature value of the second difference-value combination is determined to be less than a first default value.

The present disclosure obtains the sensing data of multiple sensors of same category and analyzes and compares the sensing data in according to the interdependence of the sensing data. Whenever two sensors are detected to have sensing data with a significant difference, the present disclosure immediately issues an alarm to notify the user to check the corresponding sensors. Therefore, the sensing data from the abnormal sensors may be prevented from affecting the accuracy of the entire system.

### BRIEF DESCRIPTION OF THE DRAWINGS

FIG. 1 is a block diagram of a testing system according to an embodiment of the present disclosure.

FIG. 2 is a flowchart of a testing method according to an embodiment of the present disclosure.

FIG. 3 is a data cleaning flowchart according to an embodiment of the present disclosure.

FIG. 4 is a value computing flowchart according to an embodiment of the present disclosure.

FIG. 5 is a value comparing flowchart according to an embodiment of the present disclosure.

FIG. 6 is a block diagram of a server according to an embodiment of the present disclosure.

FIG. 7 is an error alarming flowchart according to an embodiment of the present disclosure.

FIG. 8 is a schematic diagram showing a significant difference according to an embodiment of the present disclosure.

### DETAILED DESCRIPTION OF THE INVENTION

In cooperation with the attached drawings, the technical contents and detailed description of the present invention are described thereinafter according to multiple embodiments, being not used to limit its executing scope. Any equivalent variation and modification made according to appended claims is all covered by the claims claimed by the present invention.

In order to plan an energy-saving and carbon-emission strategy for an environment (such as a building), a bunch of sensors has to be arranged within the environment. Sensing data generated by the sensors are used for statistics and analysis to plan the strategy. However, these sensing data should be tested before being used. Therefore, wrong strategies can be prevented due to the inaccurate sensing data.

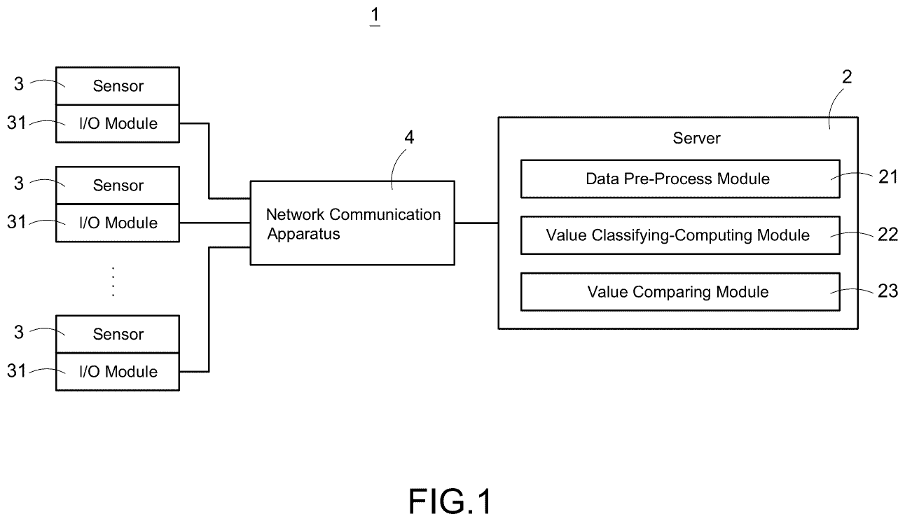

Please refer to FIG. 1, which is a block diagram of a testing system according to an embodiment of the present disclosure. The present disclosure discloses a testing system for sensor data (referred to as the testing system 1 hereinafter). As shown in FIG. 1, the testing system 1 includes a server 2 and multiple sensors 3, where each of the sensors 3 respectively includes a corresponding I/O module 31. The server 2 connects with a network communication apparatus 4 through an Internet protocol and connects with the I/O module 31 of each of the sensors 3 through the network communication apparatus 4.

The testing system 1 of the present disclosure may be arranged in a specific environment such as a building. Multiple sensors 3 of different categories such as thermometers, hygrometers, and air quality detectors, etc. are arranged in the building. One of the technical features of the present disclosure is that the server 2 continuously receives the sensing data from all of the sensors 3 through the network communication apparatus 4 and compares the sensing data of multiple sensors 3 of same category to detect whether an abnormal sensor exists within the multiple sensors 3 of same category. As mentioned above, the server 2 of the present disclosure compares the sensing data generated by multiple sensors 3 of same category. If n categories of the sensors 3 are included in the testing system 1, the server 2 will perform the testing action for n times to respectively test whether an abnormal sensor(s) exist within each category's sensors 3.

For the sake of understanding, the following description uses the server 2 connecting with multiple sensors 3 of one single category through the network communication apparatus 4 as an example.

The multiple sensors 3 are respectively arranged in multiple same or difference areas within same environment (such as same building) to sense each of the areas and generate the sensing data correspondingly. In one embodiment, each of the sensors 3 respectively senses the environment and generate the corresponding sensing data in accordance with a preset sensing cycle (for example, setting every 100 ms, every 10 ms, or every Is as one cycle). In particular, each of the sensors 3 may respectively generate multiple sensing data within one sensing cycle, the sensors 3 are not limited to generate only one sensing data within one sensing cycle.

Each of the sensors 3 respectively includes at least one I/O module 31, each I/O module 31 respectively retrieves the sensing data being generated while the sensor 3 is operating. In one embodiment, the I/O module 31 is a wireless transmission interface and the sensor 3 wirelessly connects with the network communication apparatus 4 through the I/O module 31. In other embodiment, the I/O module 31 is a wired transmission interface and the sensor 3 connects with the network communication apparatus 4 through the I/O module 31 with a cable.

The server 2 connects with the network communication apparatus 4 through the Internet and then connects with each of the sensors 3 through the network communication apparatus 4. In the present disclosure, the server 2 continuously receives the sensing data from the multiple sensors 3 through the network communication apparatus 4 and the multiple I/O modules 31.

In the embodiment of FIG. 1, the server 2 is divided into a data pre-process module 21, a value classifying-computing module 22, and a value comparing module 23 based on the functions being required. It should be mentioned that the testing system 1 of the present disclosure further includes a database (not shown), and the server 2 stores all the collected sensing data in the database.

In one embodiment, the data pre-process module 21, the value classifying-computing module 22, and the value comparing module 23 are hardware modules implemented by physical components, such as a micro control unit (MCU), a central process unit (CPU), a system on chip (SoC), or a programmable logic controller (PLC), etc. In other embodiment, the server 2 records computer executable program codes. After being activated and executing the computer executable program codes, the server 2 may create and run the aforementioned data pre-process module 21, the value classifying-computing module 22, and the value comparing module 23 in accordance with the required functions. In other words, the aforementioned modules 21-23 are software modules, but not limited thereto.

The data pre-process module 21 performs a data cleaning procedure to the sensing data of the multiple sensors 3 to generate multiple cleaned data before an analysis comparing procedure is performed. If each of the sensors 3 respectively generates multiple sensing data, the data pre-process module 21 performs the data cleaning procedure for each of the sensors 3 to respectively generate multiple cleaned data for each sensor 3.

In one embodiment, the server 2 receives the sensing data of the multiple sensors 3 of all category through the network communication apparatus 4. Before the analysis comparing procedure, the server 2 first classifies the sensing data through the data pre-process module 21 to gather the sensing data from multiple sensors 3 of same category into same data set. For example, the data pre-process module 21 may gather the sensing data corresponding to multiple flow meters into a first data set and gather the sensing data corresponding to multiple thermometers into a second data set, and so on. After classifying, the data pre-process module 21 performs the data cleaning procedure to the multiple sensing data of same category.

During the data cleaning procedure, the data pre-process module 21 filers blank data, abnormal data, and outlier data out of the data set, so as to reduce the deviation of the analysis comparing procedure caused by these noises.

The value classifying-computing module 22 is used to obtain the multiple cleaned data processed by the data pre-process module 21 and then compare the multiple cleaned data to generate one or more comparing results correspondingly. The testing system 1 of the present disclosure tests one or more sensors 3 suspected to be abnormal based on the comparing results.

In particularly, the value classifying-computing module 22 calculates a difference value for every two cleaned data in same data set, according to a designated order-direction, to generate a difference-value combination that includes multiple difference values. In other words, if sensing data from n sensors 3 of same category is included in one data set, the value classifying-computing module 22 calculates C₂ⁿ difference-value combinations. For example, if a data set includes the sensing data from four sensors 3 of the same category, the value classifying-computing module 22 calculates six difference-value combinations (C₂⁴=6).

More specifically, according to the data amount that each of the sensors 3 may generate within one sensing cycle, each of the difference-value combination may include multiple difference values. For example, if each of the sensors 3 respectively generates one hundred sensing data within one sensing cycle, each of the difference-value combinations respectively includes one hundred difference-values.

While calculating the difference-value, the value classifying-computing module 22 picks any two sensors 3 of same category and obtains all cleaned data of these two sensors 3. The data amount of the picked cleaned data from a first sensor should be identical to that of the picked cleaned data from a second sensor. Next, the value classifying-computing module 22 respectively picks one cleaned data from each of the two sensors 3 (e.g., based on sensing time of the data) and subtracts one cleaned data from another to generate a difference value. After all the picked cleaned data of the two sensors 3 are subtracted in pairs, the value classifying-computing module 22 may generate multiple difference values and then generate a difference-value combination associated with the two picked sensors 3 based on the multiple difference values.

One technical feature of the present disclosure is that the server 2 performs the analysis comparing procedure based on multiple difference-value combinations and detects whether a significant difference exists in a sensing data population between any two of the sensors 3. In sum, the server 2 may find out one or more abnormal sensors 3 (or suspected to be abnormal) based on whether a significant difference exists in the sensing data population.

The value comparing module 23 is used to obtain a measuring-accuracy value of a certain category of sensor (such as flow meters, thermometers, or hygrometers, etc.) and detect the abnormal data based on the measuring-accuracy value.

In particularly, the measuring-accuracy value corresponding to a certain category is a known information after the sensors 3 of this category have been manufactured. The manufacturer of the sensors 3 may provide the measuring-accuracy value and import the measuring-accuracy value into the testing system 1. It should be noticed that all the sensors 3 of same category should have same measuring-accuracy value.

In the present disclosure, the value comparing module 23 obtains the difference-value combinations calculated by the value classifying-computing module 22 and subtracts the corresponding measuring-accuracy value from every difference value of each of the difference-value combinations to generate multiple second difference-value combinations. Next, the value comparing module 23 respectively calculates a first feature value of each of the second difference-value combinations and obtains a corresponding p-value based on each of the second difference-value combinations and its first feature value.

In one embodiment, the first feature value may be, for example but not limited to, an expected value, an average value, or a geometric mean, etc. The present disclosure observes whether a significant difference exists in the multiple sensing data (i.e., the multiple cleaned data) of this category by testing the expected value, the average value, or the geometric mean of each of the second difference-value combinations.

The p-value mentioned above is known in the field, the detailed description is omitted here. If the p-value corresponding to the first feature of one second difference-value combination (such as 1^{st} second difference-value combination) is less than a first default value, a significant difference will be regarded as being existed in the sensing data population of the two sensors 3 corresponding to the 1st second difference-value combination: If the p-value corresponding to the first feature of one second difference-value combination (such as 2^{nd} second difference-value combination) is not less than the first default value, no significant difference will be regarded as being existed in the sensing data population of the two sensors 3 corresponding to the 2^{nd} second difference-value combination.

More specifically, the present disclosure calculates multiple difference values (to generate a difference-value combination) and one feature value based on the multiple sensing data of two sensors 3 of same category, so as to obtain a corresponding p-value eventually. Therefore, the p-value may be used to determine whether a significant difference exists between the multiple sensing data of the two sensors 3.

For example, a first thermometer generates n sensing data in one sensing cycle and a second thermometer generates n sensing data in the same sensing cycle as well. If a p-value obtained according to these sensing data is too small (e.g., less than the first default value), it means a significant difference exists between the n sensing data of the first thermometer and the n sensing data of the second thermometer. However, which thermometer is abnormal cannot be determined yet on this stage. Therefore, the two thermometers have to be labeled and then detected in the following procedures (detailed discussed in the following).

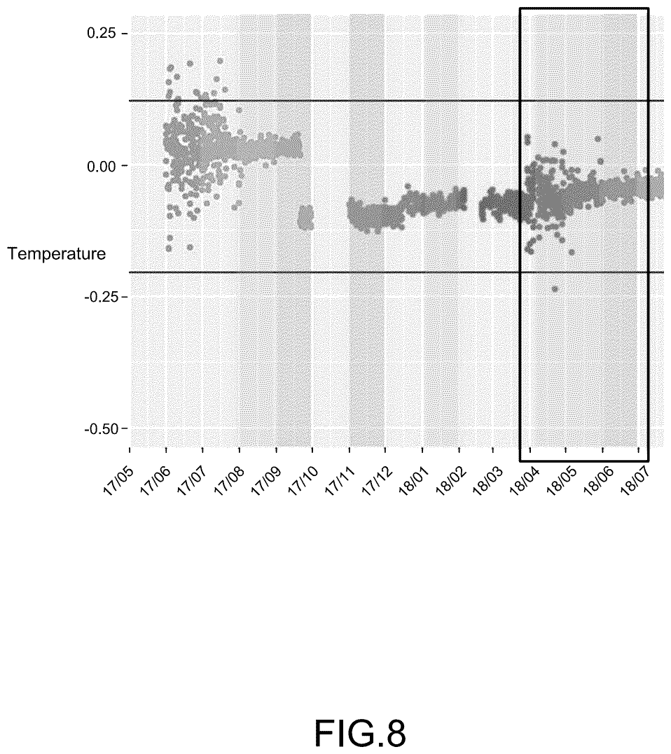

Please refer to FIG. 8 at the same time, wherein FIG. 8 is a schematic diagram showing a significant difference according to an embodiment of the present disclosure. In the embodiment of FIG. 8, two thermometers are tested in October 2017 and operate since November 2017. It can be seen from FIG. 8 that one of the thermometers (a first thermometer) is abnormal starting from April 2018 (marked by the square box), it turns out that a significant difference exists between the data of the first thermometer and the data of another thermometer (a second thermometer). After June 2018, the first thermometer has been changed and the data is back to normal since then. After all, no significant difference is left between the data of the first thermometer and the data of the second thermometer.

If the value comparing module 23 determines that the p-value corresponding to a first feature of one difference-value combination is less than the first default value, it means that a significant difference exists in the sensing data population of the two sensors 3 corresponding to this difference-value combination. In this case, the value comparing module 23 records a label for the two sensors 3. One technical feature of the present disclosure is that the testing system 1 may detect an abnormal sensor from the multiple sensors 3 by using the labels (detailed described in the following).

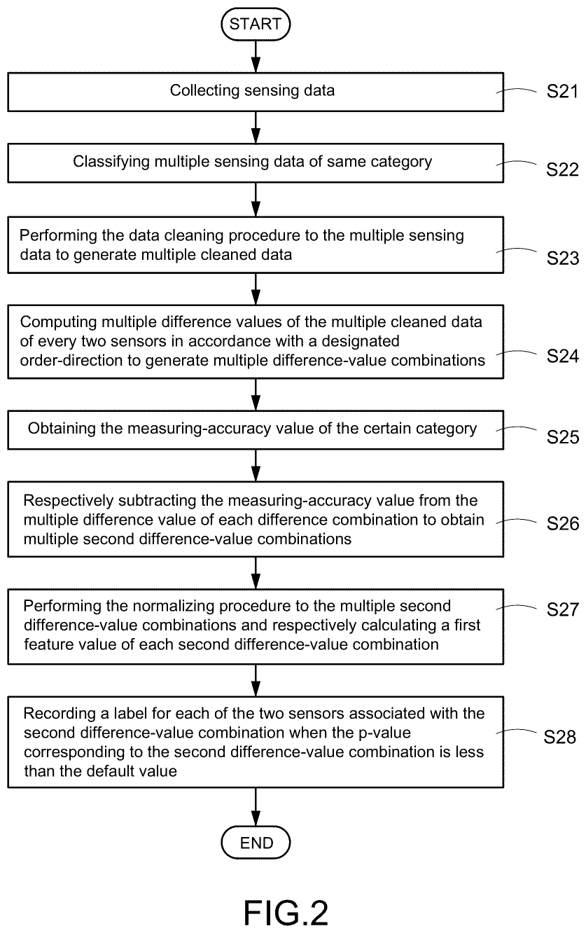

Please refer to FIG. 2 at the same time, wherein FIG. 2 is a flowchart of a testing method according to an embodiment of the present disclosure. FIG. 2 discloses the specific steps of the testing method for sensor data of the present disclosure (referred to as the testing method hereinafter). The testing method is incorporated with the testing system 1 as shown in FIG. 1, but not limited thereto.

As shown in FIG. 2, after the testing system 1 is activated, the server 2 continuously collects the sensing data of the multiple sensors 3 connected with the server 2 (step S21), and the server 2 classifies the multiple sensing data collected (step S22), so as to gather the sensing data from multiple sensors 3 of same category into same data set.

Before performing the analysis comparing procedure to the multiple sensing data of each category, the server 2 performs, for each category, the data cleaning procedure to the multiple sensing data of same category to generate multiple cleaned data (step S23). For the sake of understanding, the following description is an example of gathering multiple cleaned data of same category into one data set and performing the analysis comparing procedure to the multiple cleaned data in one single data set.

After step S23, the server 2 computes multiple difference-value combinations of the multiple cleaned data from every two sensors of a certain category of the data set in accordance with a designated order-direction (step S24), wherein each of the difference-value combinations respectively includes multiple difference values of the multiple cleaned data of two sensors of the certain category being compared. For example, if the data set includes one hundred first cleaned data generated by a first sensor in a first sensing cycle, one hundred second cleaned data generated by a second sensor in the first sensing cycle, and one hundred third cleaned data generated by a third sensor in the first sensing cycle, the multiple difference-value combinations may include a difference-value combination A that records one hundred difference values of the first cleaned data from the first sensor and the second cleaned data from the second sensor, a difference-value combination B that records hundred difference values of the second cleaned data from the second sensor and the third cleaned data from the third sensor, and a difference-value combination C that records one hundred difference values of the first cleaned data from the first sensor and the third cleaned data from the third sensor.

Next, the server 2 obtains the measuring-accuracy value of the certain category (step S25) and obtains multiple second difference-value combinations by subtracting the measuring-accuracy value obtained in the step S25 from every difference value of the multiple difference combinations obtained in the step S24 (step S26).

Each of the difference values may become a negative value after subtracting the measuring-accuracy value. After the step S26, the server 2 performs a normalizing procedure to the multiple difference values of the multiple second difference-value combinations and then respectively calculates a first feature value of each of the second difference-value combinations (step S27). In one embodiment, the sever 2 calculates an expected value of the multiple difference values of each of the second difference-value combinations in the step S27. In another embodiment, the server 2 calculates an average value of the multiple difference values of each of the second difference-value combinations in the step S27. In a further embodiment, the server 2 calculates a geometric mean of the multiple difference values of each of the second difference-value combinations in the step S27. However, the above descriptions are only few exemplary embodiments of the present disclosure, but not limited thereto.

After the step S27, the server 2 obtains a p-value for each of the second difference-value combinations based on the multiple difference values of each of the second difference-value combinations and the first feature value of each of the second difference-value combinations, and then determines whether each of the p-values is less than the first default value. In one embodiment, the first default value may be, for example but not limited to, 0.05, 0.03, or 0.01, etc. If the p-value corresponding to the first feature value of one of the multiple second difference-value combinations is less than the first default value, the server 2 asserts that a significant difference exists in the sensing data population between the two sensors 3 associated with this second difference-value combination. In this case, the server 2 records a label for each of the two sensors 3 after the two sensors 3 have been found to have a significant difference in the sensing data population (step S28).

Through the labels recorded in the step S28, the server 2 may know the sensors 3 that are suspected to be abnormal and determines whether to issue an alarm against the abnormal sensors (detailed discussed in the following).

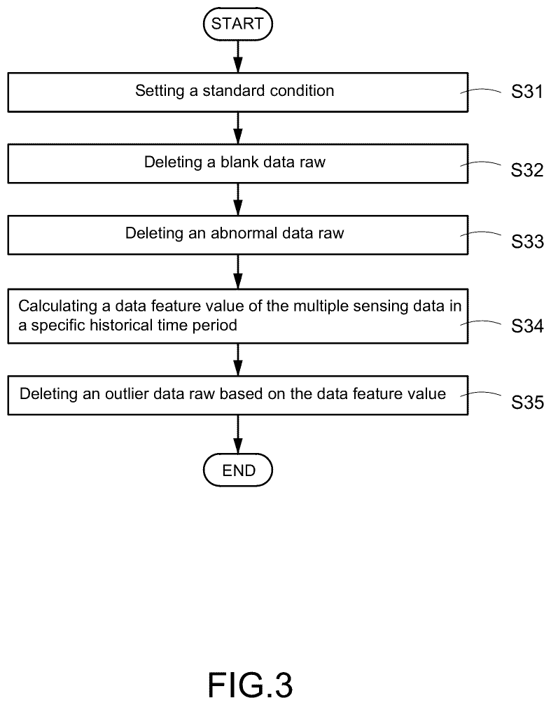

As shown in FIG. 3, when the server 2 performs the data cleaning procedure through the data pre-process module 21, a standard condition may be set manually by the user or automatically by the server 2, and the multiple sensing data in one data set may be initially filtered (step S31). In particularly, the data pre-process module 21 filters the sensing data of the multiple sensor 3 that have same condition as the standard condition being set from the data set.

For example, the standard condition may be set as turning on, operating, and without being maintained during a certain time period (such as work time from Monday to Friday). Therefore, the server 2 may first eliminate one or more sensors 3 that didn't turn on during this time period, did turn on but not operate during this time period, or had been maintained during this time period. Without using the sensing data of these sensors 3 that are unsatisfying the standard condition, misjudgment of the server 2 can be prevented.

Next, the data pre-process module 21 deletes a blank data raw(s) from the multiple sensing data of the data set (step S32) and deletes an abnormal data raw(s) from the multiple sensing data of the data set (step S33). In one embodiment, the abnormal values of the abnormal data raw may be, for example but not limited to, N/A, gibberish, special symbols, or noises recorded in the data raw.

After the step S32 and the step S33, the data pre-process module 21 calculates a data feature value of the multiple sensing data in a specific historical time period being set (step S34). In one embodiment, the data feature value may be an average value or a geometric mean, etc. of the multiple sensing data in the specific historical time period, but not limited thereto.

For example, the specific historical time period may be set, manually by the user or automatically by the server 2, as the fifth month. Therefore, the data pre-process module 21 may calculate the data feature value based on the sensing data from the previous four months as well as the sensing data from the fifth month. Next, the data pre-process module 21 deletes an outlier data raw(s) from the multiple sensing data based on the data feature value (step S35), so as to generate the multiple cleaned data. For example, the data pre-process module 21 deletes one or more sensing data that exceed three standard deviations (SDs) from the data feature value from the multiple sensing data in the step S35, but not limited thereto. In the present disclosure, the server 2 performs the following analysis comparing procedure based on the multiple cleaned data.

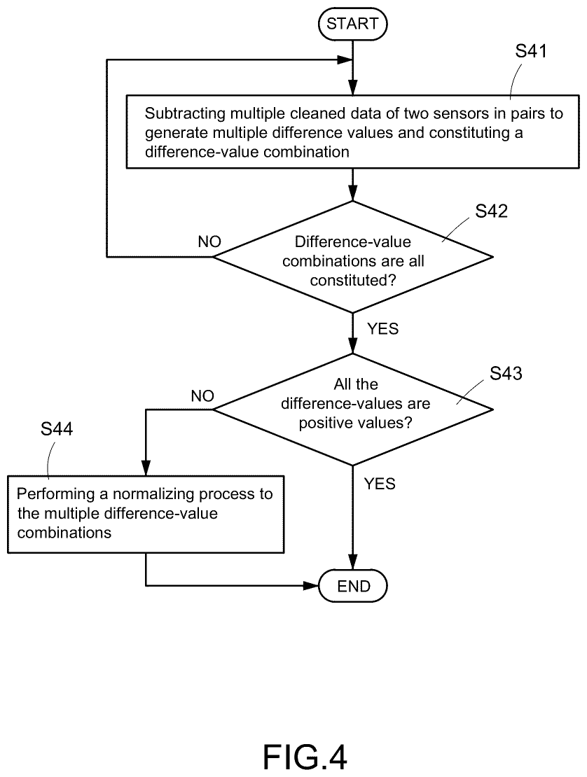

Please refer to FIG. 4, which is a value computing flowchart according to an embodiment of the present disclosure. FIG. 4 is used to detailed describe the step S24 as discussed with FIG. 2.

As shown in FIG. 4, the server 2 obtains the multiple cleaned data through the value classifying-computing module 22 and subtracts multiple cleaned data of one sensor 3 from multiple cleaned data of another sensor 3 in pairs to generate multiple difference values and further constitute a difference-value combination based on the multiple difference values (step S41). For example, the two sensors 3 respectively have one hundred cleaned data, and the value classifying-computing module 22 performs subtraction to the multiple cleaned data of the two sensors 3 for a hundred times to generate a hundred difference values to constitute the difference-value combination based on the hundred difference values. Besides, the value classifying-computing module 22 determines whether all the difference-value combinations are all calculated and constituted (step S42), i.e., the value classifying-computing module 22 determines whether the sensing data population of every two sensors have been subtracted in pairs according to the designated order-direction to generate a corresponding difference-value combination. If the difference-value combinations have not been calculated and constituted completely, the value classifying-computing module 22 goes back to step S41.

For example, the server 2 connects with four sensors 3 of same category, wherein the four sensors 3 includes a first sensor S1, a second sensor S2, a third sensor S3, and a fourth sensor S4. In the step S41, the value classifying-computing module 22 calculates, in a designated order-direction, a difference-value combination D12 (i.e., S2-S1), a difference-value combination D13 (i.e., S3-S1), a difference-value combination D14 (i.e., S4-S1), a difference-value combination D23 (i.e., S3-S2), a difference-value combination D24 (i.e., S4-S2), and a difference-value combination D34 (i.e., S4-S3). In other words, if the amount of the sensor 3 of same category is n, the value classifying-computing module 22 may calculate C₂ⁿ difference-value combinations where each of the difference-value combinations respectively includes multiple difference values of the sensing data population of two sensors 3.

After all the difference-value combinations are calculated and constituted completely, the value classifying-computing module 22 further determines whether all the difference-values in these difference-value combinations are positive values (step S43). If all the difference values are positive values (including zero), the value classifying-computing module 22 does not perform any action, and then the server 2 proceeds the step S25 to the step S28 of FIG. 2. If at least one of the difference values is a negative value, the value classifying-computing module 22 performs a normalizing process to all difference values of all difference-value combinations (step S44). Next, the server 2 executes the step S25 to the step S28 of FIG. 2 after the step S44.

In one embodiment, the value classifying-computing module 22, in the step S44, obtains a smallest difference value from the multiple difference-value combinations and subtracts the smallest difference value from all difference values of the multiple difference-value combinations to finish the normalizing process. In particularly, if the determination made by the value classifying-computing module 22 in the step S43 is negative, the smallest difference value of the multiple difference-value combinations is definitely a negative value. Therefore, the smallest difference value will be calibrated to zero after subtracting the smallest difference value from all of the difference values of all difference-value combinations. In the meantime, the rest of the difference values will be calibrated to another positive value greater than zero. Therefore, the value classifying-computing module 22 may finish the normalizing process for the multiple difference values.

For example, the difference combination D12 includes difference values of 2, 1, −1, −2, 4, and 0, wherein the smallest difference value is −2. In this embodiment, the value classifying-computing module 22 subtracts −2 from all difference values of all difference-value combinations. The multiple difference values of the difference-value combination D12 after the normalizing process may include 2−(−2)=4, 1−(−2)=3, −1−(−2)=1, −2−(−2)=0, 4−(−2)=6, and 0−(−2)=2. As discussed above, the value classifying-computing module 22 transforms every difference value into a positive value by performing the normalizing process.

It should be mentioned that if all the difference values of one difference-value combination (such as D12 or D23, etc.) are positive values, the normalizing process is unnecessary for this difference-value combination.

In the present disclosure, the server 2 performs the analysis comparing procedure based on the difference-value combinations after the normalizing process. By eliminating negative difference value(s), the complexity of the analysis comparing procedure may be reduced.

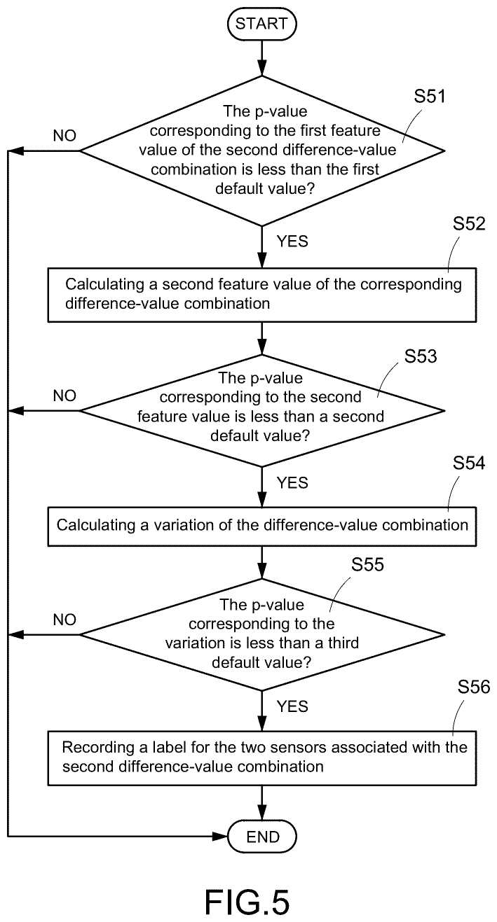

Please refer to FIG. 5, which is a value comparing flowchart according to an embodiment of the present disclosure. FIG. 5 is used to detailed describe the step S28 of FIG. 2.

In the embodiment of FIG. 2, the server 2 calculates multiple second difference-value combinations based on the multiple difference-value combinations and the measuring-accuracy value of a target category, and then respectively calculates the first feature value of each of the second difference-value combinations. Besides, the server 2 respectively generates a p-value corresponding to each of the second difference-value combinations based on each of the second difference-value combinations and its first feature value. When any second difference-value combination's p-value is determined to be smaller than the first default value, the server 2 records a corresponding label to the two sensors 3 that are associated with this second difference-value combination. The above procedure of FIG. 2 may be regarded as a first stage of the analysis comparing procedure performed by the server 2 through the value comparing module 23. In other words, in the embodiment of FIG. 2, the value comparing module 23 directly labels the two sensors 3 being found to have a significant difference in the sensing data population after the first stage of analysis comparing procedure.

In the embodiment of FIG. 5, the value comparing module 23 performs multiple stages of the analysis comparing procedure before labeling the two sensors 3.

In particular, in the embodiment of FIG. 5, after calculating the first feature value of each second difference-value combination, the value comparing module 23 respectively generates a p-value corresponding to each of the second difference-value combinations based on each of the second difference-value combinations and its first feature value, and then the value comparing module 23 determines whether the p-value corresponding to each first feature value is less than the first default value (step S51). If the p-value corresponding to the first feature value of one of the second difference-value combinations (such as a 1^{st} second difference-value combination) is not less than the first default value, it means no significant difference exists in the sensing data population between the two sensors that are associated with the 1^{st} second difference-value combination. Therefore, the value comparing module 23 does not label the two sensors 3.

In the embodiment of FIG. 5, the value comparing module 23 does not performs the labeling action temporarily even if the p-value corresponding to the first feature value of the 1^{st} second difference-value combination is determined to be less than the first default value in the step S51, instead, the value comparing module 23 further performs a second stage of the analysis comparing procedure.

In particularly, the value comparing module 23 respectively calculates a second feature value of each of the difference-value combinations in the second stage of the analysis comparing procedure (step S52), wherein the second feature value may be, for example but not limited to, an expected value, an average value, or a geometric mean, etc., of the multiple difference values of each of the difference-value combinations.

After calculating the second feature value of each of the difference-value combinations, the value comparing module 23 respectively obtains a p-value corresponding to each of the difference-value combinations based on each of the difference-value combinations and its second feature value, and then the value comparing module 23 determines whether each of the p-values corresponding to each of the second feature values is less than a second default value (step S53). In one embodiment, the second default value may be identical to the first default value. In another embodiment, the second default value may be any value selected from 0.01 to 0.05, but not limited.

In one embodiment, the value comparing module 23 asserts that a significant difference exists in the sensing data population between two sensors 3 associated with one difference-value combination (such as a 1^{st} difference-value combination) when the p-value corresponding to the second feature value of the 1^{st} difference-value combination is less than the second default value. In this case, the value comparing module 23 records a label for the two sensors 3 being found to have a significant difference in the sensing data population. In another embodiment, the value comparing module 23 does not perform the labeling action temporarily even if the p-value corresponding to the second feature value of any difference-value combination is determined to be less than the second default value, instead, the value comparing module 23 performs a third stage of the analysis comparing procedure.

In the third stage of the analysis comparing procedure, the value comparing module 23 respectively calculates a variation of the multiple difference values of each of the difference-value combinations (step S54). After the variation of the multiple difference values of each of the difference-value combinations is calculated, the value comparing module 23 respectively obtains a p-value corresponding to each of the difference-value combinations based on each of the difference-value combinations and its variation, and then the value comparing module 23 determines whether each of the p-values corresponding to each of the variations is less than a third default value (step S55). In one embodiment, the third default value is smaller than the first default value and the second default value. In another embodiment, the third default value is 0.01, but not limited thereto.

In the embodiment, when the p-value corresponding to any difference-value combination's variation is determined to be less than the third default value, the value comparing module 23 asserts that a significant difference exists in the sensing data population between the two sensors 3 that are associated with this second difference-value combination (or the difference-value combination corresponding to this second difference-value combination). In this case, the value comparing module 23 records a label for the two sensors 3 (step S56).

The present disclosure detects each p-value corresponding to the first feature value of each second difference-value combination, each p-value corresponding to the second feature value of each difference combination, and each p-value of the variation of each difference combination in an order, wherein the determination for the p-values may help the server 2 to understand the data distribution of data difference values for each two sensors. Therefore, the server 2 may confirm whether a significant difference exists.

If the server 2 determines in the first stage of the analysis comparing procedure that a significant difference exists, the server 2 further performs the second stage of the analysis comparing procedure; if the server 2 determines in the second stage of the analysis comparing procedure that a significant difference still exists, the server 2 further performs the third stage of the analysis comparing procedure. The present disclosure detects the multiple sensing data population of the multiple sensors 3 through multiple stages of the analysis comparing procedure like a filtering process, which can avoid misjudgment caused by rough detection conditions.

In one embodiment, the server 2 may perform the aforementioned analysis comparing procedure in accordance with a preset testing cycle, for example, one time per month, but not limited. Taking the testing cycle as one time per month as an example, the labels recorded by the server 2 may be indicated as the table 1 below:

TABLE 1

| Month | | 1 | 2 | 3 | 4 | 5 | 6 | 7 |
|---|---|---|---|---|---|---|---|---|
| Labels | D12 | X | | X | X | | X | |
| For | D13 | X | | X | X | | X | |
| Difference- | D14 | X | | X | X | | X | |
| value | D23 | | | | | | | |
| Combinations | D24 | | X | | | | | |
| | D34 | | | | | | | |

In the embodiment shown in the above table 1, the server 2 performs the analysis comparing procedure on the basis of one month, wherein the server 2 determines that a significant difference exists in the difference-value combinations D12, D13, and D14 and labels the multiple sensors 3 associated with the difference-value combinations D12, D13, and D14 in January, determines that a significant difference exists in the difference-value combination D24 and labels the multiple sensors 3 associated with the difference-value combination D24 in February, determines that a significant difference exists in the difference-value combinations D12, D13, and D14 and labels the multiple sensors 3 associated with the difference-value combinations D12, D13, and D14 in March, determines that a significant difference exists in the difference-value combinations D12, D13, and D14 and labels the multiple sensors 3 associated with the difference-value combinations D12, D13, and D14 in April, and determines that a significant difference exists in the difference-value combinations D12, D13, and D14 and labels the multiple sensors 3 associated with the difference-value combinations D12, D13, and D14 in June.

According to the above labels, the server 2 may detect one or more sensors 3 that are suspected to be abnormal. For example, if the difference-value combination D12 is labeled, it means that the first sensor S1 and/or the second sensor S2 may be abnormal; if the difference-value combination D24 is labeled, it means the second sensor S2 and/or the fourth sensor S4 may be abnormal.

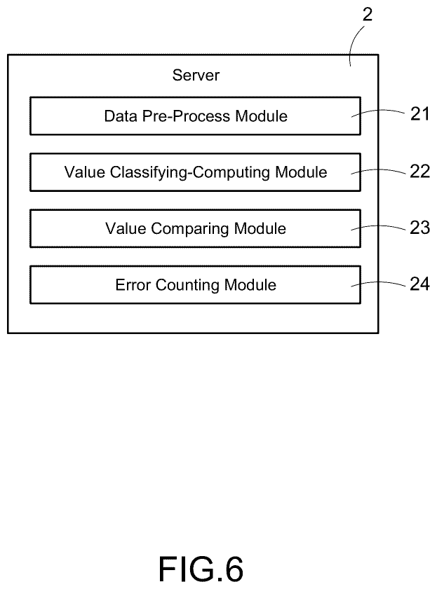

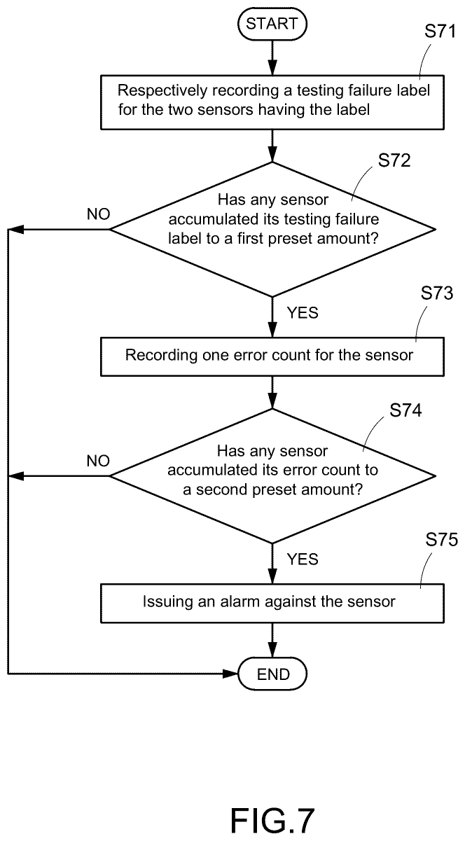

Please refer to FIG. 6 and FIG. 7 at the same time, wherein FIG. 6 is a block diagram of a server according to an embodiment of the present disclosure and FIG. 7 is an error alarming flowchart according to an embodiment of the present disclosure.

In the embodiment of FIG. 6, the server 2 further includes an error counting module 24. As mentioned above, the value comparing module 23 may record a label for multiple sensors 3 being found to have a significant difference in the sensing data population after one or more stages of the analysis comparing procedure are performed (for example, multiple sensors 3 associated with the difference-value combinations D12, D13, D14, and D24 are recorded with a label in the above table 1). One difference-value combination is associated with two sensors 3 of same category. In the present disclosure, the error counting module 24 records the label for the two sensors correspondingly based on the label of one difference-value combination associated with the two sensors 3.

As shown in FIG. 7, in the present disclosure, the server 2 uses the error counting module 24 to record a testing failure label respectively for the two sensors 3 associated with the difference-value combination being labeled (step S71). In one embodiment, two sensors 3 that are associated with a difference-value combination not being labeled may also be recorded with the testing failure label which is 0.

In particularly, the testing failure label may be indicated as the following table 2.

TABLE 2

| Month | | 1 | 2 | 3 | 4 | 5 | 6 | 7 |
|---|---|---|---|---|---|---|---|---|
| Labels | D12 | X | | X | X | | X | |
| For | D13 | X | | X | X | | X | |
| Difference- | D14 | X | | X | X | | X | |
| value | D23 | | | | | | | |
| Combinations | D24 | | X | | | | | |
| | D34 | | | | | | | |
| Testing | S1 | 3 | 0 | 3 | 3 | 0 | 3 | 0 |
| Failure | S2 | 1 | 1 | 1 | 1 | 0 | 1 | 0 |
| Labels | S3 | 1 | 0 | 1 | 1 | 0 | 1 | 0 |
| For | S4 | 1 | 1 | 1 | 1 | 0 | 1 | 0 |
| Sensors | | | | | | | | |

As disclosed in the above table 2, the server 2 labels the difference-value combinations D12, D13, and D14 in the analysis comparing procedure in January. In the step S71, the error counting module 24 records three testing failure labels for the first sensor S1 (associated with the difference-value combinations D12, D13, and D14), records one testing failure label for the second sensor S2 (associated with the difference-value combination D12), records one testing failure label for the third sensor S3 (associated with the difference-value combination D13), and records one testing failure label for the fourth sensor S4 (associated with the difference-value combination D14).

For another example, the server 2 labels the difference-value combination D24 in the analysis comparing procedure in February. In the step S71, the error counting module 24 records one testing failure label for the second sensor S2 and also records one testing failure label for the fourth sensor S4.

Please refer back to FIG. 7. After the labeling action for this time (including the labeling action for the difference-value combination(s) as well as the labeling action for the sensor(s) 3), the server 2 determines whether the testing failure label of any sensor 3 has accumulated to a first preset amount (step S72). In one embodiment, the first preset amount may be three, but not limited. When any sensor 3 in the current testing cycle has accumulated its testing failure label to the first preset amount, the error counting module 24 records one error count for this sensor 3 (step S73).

If the first preset amount is three, in the embodiment shown in the above table 2, the first sensor S1 has accumulated its testing failure labels to three in the testing cycles of January, March, April, and June. In this embodiment, the error counting module 24 accumulates an error count for the first sensor S1 respectively in the analysis comparing procedures of January, March, April, and June.

In particular, the error count may be indicated as the table 3 below:

TABLE 3

| Month | | 1 | 2 | 3 | 4 | 5 | 6 | 7 |
|---|---|---|---|---|---|---|---|---|
| Testing | S1 | 3 | 0 | 3 | 3 | 0 | 3 | 0 |
| Failure | S2 | 1 | 1 | 1 | 1 | 0 | 1 | 0 |
| Labels | S3 | 1 | 0 | 1 | 1 | 0 | 1 | 0 |
| For | S4 | 1 | 1 | 1 | 1 | 0 | 1 | 0 |
| Sensors | | | | | | | | |
| Accumulated | S1 | 1 | 1 | 2 | 3 | 3 | 4 | 0 |
| Error | S2 | 0 | 0 | 0 | 0 | 0 | 0 | 0 |
| Counts | S3 | 0 | 0 | 0 | 0 | 0 | 0 | 0 |
| Of | S4 | 0 | 0 | 0 | 0 | 0 | 0 | 0 |
| Sensors | | | | | | | | |

It can be seen from the above table 3 that, the error counting module 24 of the present disclosure calculates the error count on the basis of per testing cycle. If one sensor (taking the first sensor S1 for example) has accumulated its testing failure labels to the first preset amount in the current testing cycle, the error counting module 24 will record (accumulate) the error count for one time for this sensor 3; If a sensor (taking the second sensor S2, the third sensor S3, and the fourth sensor S4 for example) accumulates its testing failure labels less than the first preset amount in the current testing cycle, the error counting module 24 will not record the error count for this sensor 3 in this testing cycle.

In the present disclosure, when entering the next testing cycle (i.e., when the analysis comparing procedure is performed next time) the testing failure labels of each sensor 3 will not be accumulated, while the error count of each sensor 3 will be accumulated.

As shown in FIG. 7, when one testing cycle ends, the error counting module 24 determines whether the error count of any sensor 3 reaches a second preset amount (step S74). In one embodiment, the second preset amount may be three, but not limited thereto. In one embodiment, it is unnecessary for the error count to be accumulated without interruption but the total amount will accrue before the sensor 3 is maintained or changed.

When determining that one sensor 3 has accumulated its error count to the second preset amount in the step S74, the server 2 may issue an alarm against this sensor 3 (step S75). Therefore, the user may be notified that this sensor 3 is abnormal or suspected to be abnormal and then maintains or changes this sensor 3. After this sensor 3 has been maintained or changed, the error counting module 24 resets the error count of this sensor 3 to zero for the sensor 3 to re-accumulate its error count.

The present disclosure uses the testing system to collect the sensing data of multiple sensors of same category under same conditions, perform the data cleaning procedure, perform multi-stages of the analysis comparing procedure like sieves with diameters ranging from large to small, and detect the sensing data in accordance with the dependencies of the data. If a part of the sensors is found to have problems during one testing procedure, the system may record a label for this sensor and accumulate the label to next testing procedure. Whenever the accumulated labels exceed a preset amount, the system actively issues an alarm to notify the user to check, maintain, or change the corresponding sensor.

In comparing with traditional systems that need to regularly maintain the sensors or to define the upper and lower limit values for the sensors, the present disclosure analyzes and compares the data to find out an abnormal sensor in real-time. Therefore, the present disclosure ensures that the analysis and planning performed by the system based on the sensing data will not cause serious distortion or deviation due to abnormal sensors or un-calibrated sensors.

As the skilled person will appreciate, various changes and modifications can be made to the described embodiment. It is intended to include all such variations, modifications and equivalents which fall within the scope of the present invention, as defined in the accompanying claims.

What is claimed is:

1. A testing system for sensor data of monitoring system, comprising:
multiple sensors corresponding to same certain category, wherein each of the multiple sensors respectively generates multiple sensing data;
multiple I/O modules each respectively connected with one of the multiple sensors to continuously collect the multiple sensing data of each of the multiple sensors;
a server, connected with the multiple I/O modules through a network communication apparatus to receive the multiple sensing data of the multiple sensors, and comprising:
a data pre-process module, configured to perform a data cleaning procedure to the multiple sensing data of the multiple sensors to respectively generate multiple cleaned data for each of the multiple sensors;
a value classifying-computing module, configured to compute multiple difference values of the multiple cleaned data of any two of the multiple sensors in accordance with a designated order-direction to generate multiple difference-value combinations; and
a value comparing module, configured to obtain a measuring-accuracy value of the certain category, respectively subtract the measuring-accuracy value from the multiple difference values of each of the multiple difference-value combinations to obtain multiple second difference-value combinations, perform a normalizing process to each of the multiple second difference-value combinations, respectively calculate a first feature value of each of the second difference-value combinations, respectively obtain a p-value corresponding to each of the second difference-value combinations based on each of the second difference-value combinations and its first feature value, and record a label for two of the sensors associated with one of the second difference-value combinations when the p-value corresponding to the first feature value of the second difference-value combination is determined to be less than a first default value.

2. The testing system of claim 1, wherein the data pre-process module is configured to execute following actions to perform the data cleaning procedure to the multiple sensing data of the multiple sensors:
setting a standard condition to perform an initial filtering to the multiple sensing data;
deleting a blank data raw from the multiple sensing data;
deleting an abnormal data raw from the multiple sensing data;
computing a data feature value of the multiple sensing data within a specific historical time period, and deleting an outlier data raw from the multiple sensing data based on the data feature value.

3. The testing system of claim 2, wherein the data feature value is an average value or a geometric mean of the multiple sensing data within the specific historical time period.

4. The testing system of claim 1, wherein the value classifying-computing module is configured to determine whether the multiple difference values of each of the difference-value combinations are positive values after calculating the multiple difference-value combinations and perform the normalizing process to the multiple difference-value combinations when any of the multiple difference values is determined to be a negative value.

5. The testing system of claim 4, wherein the normalizing process comprises obtaining a smallest difference value from the multiple difference values of the multiple difference-value combinations and subtracting the smallest difference value from all of the difference values of the multiple difference-value combinations.

6. The testing system of claim 1, wherein the value comparing module is configured to calculate a second feature value of one of the difference-value combinations corresponding to one of the multiple second difference-value combinations when the p-value corresponding to the first feature value of the second difference-value combination is determined to be less than the first default value, obtain a p-value corresponding to the difference-value combination based on the difference-value combination and the second feature value, and record the label for the two sensors associated with the second difference-value combination when the p-value corresponding to the second feature value is determined to be less than a second default value.

7. The testing system of claim 6, wherein the value comparing module is configured to calculate a variation of one of the difference-value combinations when the p-value corresponding to the first feature value of one of the multiple second difference-value combinations is less than the first default value and the p-value corresponding to the second feature value of the difference-value combination is less than the second default value, obtain a p-value corresponding to the difference-value combination based on the difference-value combination and the variation, and record the label for the two sensors associated with the second difference-value combinations when the p-value corresponding to the variation is less than a third default value.

8. The testing system of claim 7, wherein the first feature value is an expected value, an average value, or a geometric mean of the multiple difference-values of the second difference-value combination and the second feature value is an expected value, an average value, or a geometric mean of the multiple difference-values of the difference-value combination.

9. The testing system of claim 1, wherein the server further comprises an error counting module, and the error counting module is configured to respectively record a testing failure label for the two sensors having the label, record an error count for one of the multiple sensors when the testing failure label of the sensor has accumulated to a first preset amount in current testing cycle, and issue an alarm against the sensor when the error count of the sensor has accumulated to a second preset amount.

10. A testing method for sensor data of monitoring system, incorporated with a testing system comprising multiple sensors and a server connected with the multiple sensors through a network communication apparatus, and the testing method comprising:
a) collecting multiple sensing data of the multiple sensors by the server;
b) classifying, by the server, the multiple sensing data to gather the multiple sensing data of the multiple sensors of a certain category;
c) performing, by the server, a data cleaning procedure to the multiple sensing data of the multiple sensors to respectively generate multiple cleaned data of each of the sensors;
d) calculating, by the server, multiple difference values of the multiple cleaned data of any two of the multiple sensors based on a designated order-direction to generate multiple difference-value combination;
e) obtaining, by the server, a measuring-accuracy value of the certain category;
f) respectively subtracting the measuring-accuracy value from the multiple difference values of each of the difference-value combinations to obtain multiple second difference-value combinations by the server; and
g) performing a normalizing process to each of the second difference-value combinations, respectively calculating a first feature value of each of the second difference-value combinations, respectively obtaining a p-value corresponding to each of the second difference-value combinations based on each of the second difference-value combinations and its first feature value, and recording a label for two of the multiple sensors associated with one of the multiple second difference-value combinations when the p-value corresponding to the first feature value of the second difference-value combination is determined to be less than a first default value.

11. The testing method of claim 10, wherein the step c) comprises:
c1) setting a standard condition to perform an initial filtering to the multiple sensing data;
c2) deleting a blank data raw from the multiple sensing data;
c3) deleting an abnormal data raw from the multiple sensing data;
c4) calculating a data feature value of the multiple sensing data within a specific historical time period; and
c5) deleting an outlier data raw from the multiple sensing data based on the data feature value to generate the multiple cleaned data.

12. The testing method of claim 11, wherein the data feature value is an average value or a geometric mean of the multiple sensing data within the specific historical time period.

13. The testing method of claim 10, wherein the step d) comprises:
d1) subtracting the multiple cleaned data of any two of the multiple sensors in pairs according to the designated order-direction to generate the multiple difference values for each two sensors and generating the multiple difference-value combinations for the multiple sensors;
d2) determining whether the multiple difference values of the multiple difference-value combinations are positive values; and
d3) performing the normalizing process to the multiple difference-value combinations when any of the multiple difference values is a negative value.

14. The testing method of claim 13, wherein the step d3) comprises obtaining a smallest difference value of the multiple difference values of the multiple difference-value combinations and subtracting the smallest difference value from all of the difference values of the multiple difference-value combinations to implement the normalizing process.

15. The testing method of claim 10, wherein the step g) comprises:
g1) determining whether each p-value corresponding to the first feature value of each of the second difference-value combinations is less than the first default value;
g2) calculating a second feature value of one of the different-value combinations corresponding to one of the multiple second difference-value combinations when the p-value corresponding to the first feature value of the second difference-value combination is less than the first feature value, and obtaining a p-value corresponding to the different-value combination based on the difference-value combination and the second feature value;
g3) determining whether the p-value corresponding to the second feature value is less than a second default value; and
g4) recording the label for the two sensors associated with the second difference-value combinations when the p-value corresponding to the second feature value is determined to be less than the second default value.

16. The testing method of claim 15, wherein the step g4) comprises:
g41) calculating a variation of the difference-value combination when the p-value corresponding to the second feature value is determined to be less than the second default value and obtaining a p-value corresponding to the difference-value combination based on the difference-value combination and the variation;
g42) determining whether the p-value corresponding to the variation is less than a third default value; and
g43) recording the label for the two sensors associated with the second difference-value combination when the p-value corresponding to the variation is determined to be less than the third default value.

17. The testing method of claim 16, wherein the first feature value is an expected value, an average value, or a geometric mean of the multiple difference-values of each of the second difference-value combinations, and the second feature value is an expected value, an average value, or a geometric mean of the multiple difference values of each of the difference-value combinations.

18. The testing method in claim 10, further comprising:
h) respectively recording a testing failure label for the two sensors having the label by the server;
i) determining, by the server, if any of the sensors has accumulated the testing failure label to a first preset amount in current testing cycle;
j) recording an error count for one of the multiple sensors when the testing failure label of the sensor has accumulated to the first preset amount in the current testing cycle; and
k) issuing an alarm against the sensor when the error count of the sensor has accumulated to a second preset amount by the server.
